(19) United States
(12) Patent Application Publication
(10) Pub. No.: US 2008/0043392 A1
(43) Pub. Date: Feb. 21, 2008

(54) Electricity limit protection switch device

(75) Inventor: Wen-Ho Yang, Bali (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SUN-LITE SOCKETS INDUSTRY INC., Kuei Shan Hsiang (TW)

(21) Appl. No.: 11/504,811

(22) Filed: Aug. 15, 2006

(51) Int. Cl. H02H 3/08

(52) U.S. Cl. 361/93.1

(57) ABSTRACT

An electricity limit protection switch includes a relay, a sample-hold circuit having a current mutual inductor and an operational amplifier, and a compare and execution circuit having a plurality of operational amplifiers to operate the signal from the sample-hold circuit and a control element to control operation of the relay according to operation of the operational amplifiers so as to turn on or turn off the relay. Thus, the electricity limit protection switch can achieve an electricity limit protection purpose by sensing the magnitude of the current passing through the load.

### BACKGROUND OF THE INVENTION

1. Field of the Invention

The present invention relates to an electricity limit protection switch device and, more particularly, to a device for protecting an electric equipment, such as a lamp or circuit, to prevent the electric equipment from being operated at an abnormal state.

2. Description of the Related Art

An electricity limit protection device is used to protect a lamp or circuit to prevent the lamp or circuit from being operated at an abnormal state. A conventional electricity limit protection device in accordance with the prior art is disclosed in the European Patent No. EP-0647084B1 and is available for operating low voltage halogen lamps. The above-mentioned conventional protection device comprises a half-bridge converter, and a sensor circuit. The sensor circuit is used to detect the situation of overload or short circuit. The sensor circuit uses a voltage signal to function as a sensing signal so as to control a shutoff circuit.

Besides, according to a law established by the California government of U.S.A. in 2006, the maximum rated power of the load of a tungsten lamp of 120 VAC/60 Hz cannot exceed 190 W so as to save the electrical energy. Thus, it is necessary to provide an electricity limit protection device having the optimal working efficiency so as to save the electrical energy and to ensure the safety of operation.

### BRIEF SUMMARY OF THE INVENTION

In accordance with the present invention, there is provided an electricity limit protection switch, comprising a circuit device comprising a relay electrically connected to a load, a sample-hold circuit including a current mutual inductor and a first operational amplifier, wherein the current mutual inductor includes a primary winding and a secondary winding, the primary winding of the current mutual inductor is electrically connected to the relay and the load, and a compare and execution circuit used to receive a signal from the sample-hold circuit and electrically connected to the relay, wherein the compare and execution circuit includes a plurality of second operational amplifiers to operate the signal from the sample-hold circuit, and a control element to control operation of the relay according to operation of the operational amplifiers so as to turn on or turn off the relay.

The primary objective of the present invention is to provide an electricity limit protection switch that can achieve an electricity limit protection purpose by sensing the magnitude of the current passing through the load.

Another objective of the present invention is to provide an electricity limit protection switch that can achieve an electricity limit protection purpose and can function as a common switch, thereby enhancing the versatility of the electricity limit protection switch.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a circuit device of an electricity limit protection switch in accordance with the preferred embodiment of the present invention.

FIG. 2 is a circuit layout of the circuit device of the electricity limit protection switch in accordance with the preferred embodiment of the present invention.

FIG. 3 is a partially exploded perspective view of the electricity limit protection switch in accordance with the preferred embodiment of the present invention.

FIG. 4 is a plan cross-sectional assembly view of the electricity limit protection switch as shown in FIG. 3.

### DETAILED DESCRIPTION OF THE INVENTION

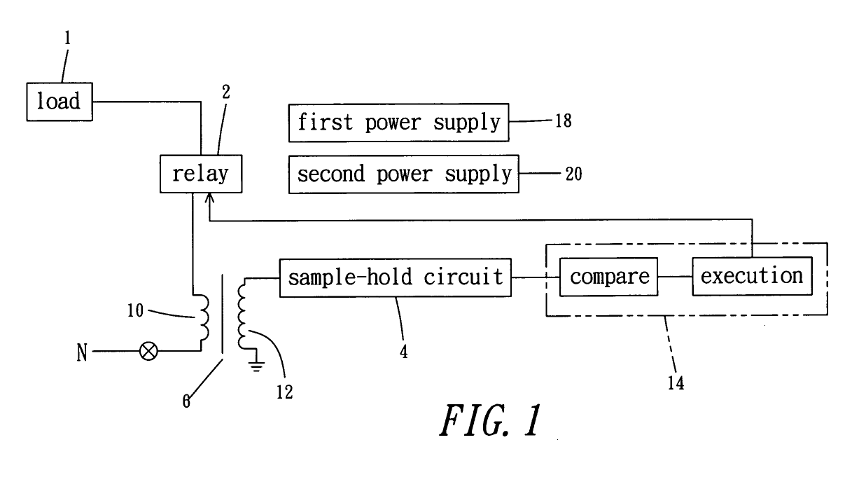

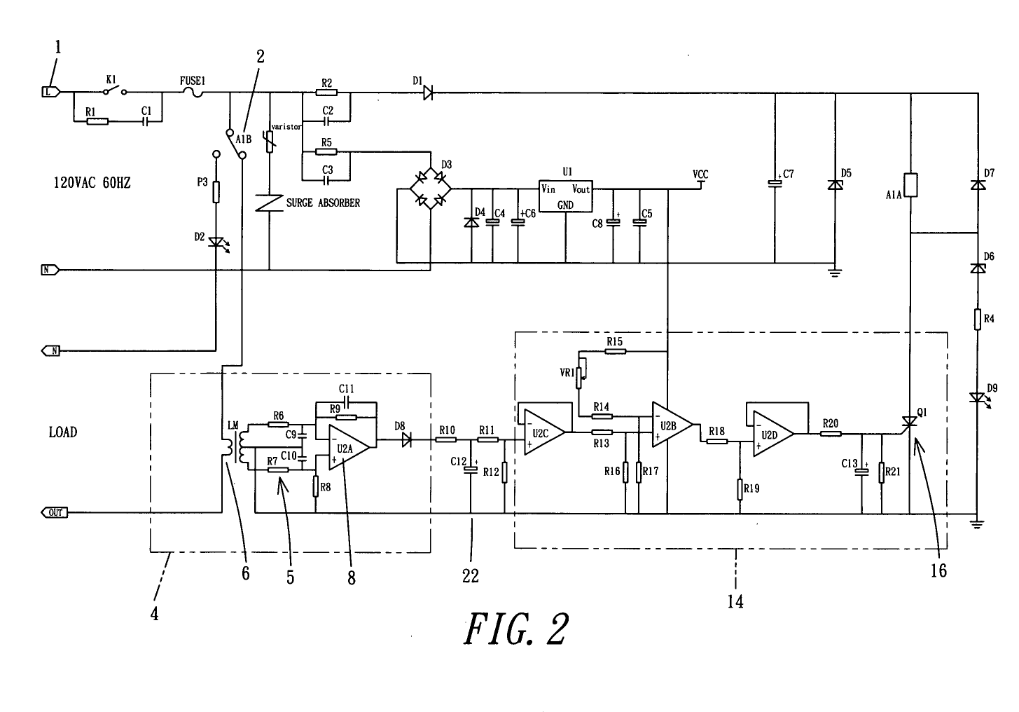

Referring to the drawings and initially to FIGS. 1 and 2, an electricity limit protection switch in accordance with the preferred embodiment of the present invention comprises a circuit device comprising a relay 2, a sample-hold circuit 4, and a compare and execution circuit 14.

The relay 2 is electrically connected to a load 1.

The sample-hold circuit 4 includes a current mutual inductor 6 and an operational amplifier 8, such as a U2A. The current mutual inductor 6 includes a primary winding 10 and a secondary winding 12. The primary winding 10 of the current mutual inductor 6 of the sample-hold circuit 4 is electrically connected to the relay 2 and the load 1. In the preferred embodiment of the present invention, the secondary winding 12 of the current mutual inductor 6 of the sample-hold circuit 4 has a center tap and is grounded.

The compare and execution circuit 14 is used to receive the signal from the sample-hold circuit 4 and is electrically connected to the relay 2. The compare and execution circuit 14 includes a plurality of operational amplifiers U2B, U2C and U2D, and a control element 16. The operational amplifiers U2B, U2C and U2D operates the signal from the sample-hold circuit 4. The control element 16 controls operation of the relay 2 according to operation of the operational amplifiers U2B, U2C and U2D so as to turn on or turn off the relay 2. In the preferred embodiment of the present invention, the control element 16 is a silicon controlled rectifier (SCR).

The sample-hold circuit 4 further includes a RC low pass filter 5 consisting of resistors R6 and R7 and capacitors C9 and C10 to filter various entering interference signals having high frequency.

The sample-hold circuit 4 further includes a difference to operation amplifier consisting of resistors R6, R7, R8 and R9, a capacitor C11 and the operational amplifier 8. The difference to operation amplifier of the sample-hold circuit 4 can amplify a difference mode signal and suppress a common mode signal. The common mode signal includes a temperature rise, an environmental noise and the like. Thus, the difference to operation amplifier of the sample-hold circuit 4 has a higher capability to pick up weaker electric signals in the noise surroundings in a stable manner without being affected by the temperature rise.

The difference to operation amplifier of the sample-hold circuit 4 is used to receive the signal from the RC low pass filter 5 of the sample-hold circuit 4.

The capacitor C11 of the difference to operation amplifier of the sample-hold circuit 4 is a Miller capacitor to compensate a signal phase shift produced by the operation and amplification.

The electricity limit protection switch further comprises a first power supply 18 and a second power supply 20. The first power supply 18 includes an electric power of 30 VDC which is supplied to the relay 2. The second power supply 20 includes an electric power of 15 VDC which is supplied to the operational amplifiers 8, U2B, U2C and U2D.

The electricity limit protection switch further comprises a delay-action circuit 22 connected between the sample-hold circuit 4 and the compare and execution circuit 14 and including a diode D8, a resistor R10 and a capacitor C12 to receive the signal amplified by the difference to operation amplifier of the sample-hold circuit 4. The delay-action circuit 22 is used to convert an alternating current signal into a direct current signal to function as a comparison signal. In addition, the basis voltage produced by the VCC, R15, VR1, R14 and R17 of the compare and execution circuit 14 is delayed about one to four (1-4) seconds to ensure stability and reliability of operation.

In operation, when the electricity limit protection switch is electrically connected to the load 1, the secondary winding 12 of the current mutual inductor 6 of the sample-hold circuit 4 has a sensed voltage whose magnitude is responsive to that of the current passing through the primary winding 10 of the current mutual inductor 6 of the sample-hold circuit 4 is further responsive to that of the load 1. More specifically, when the load 1 is working, the current will pass through the primary winding 10 of the current mutual inductor 6 of the sample-hold circuit 4. In the preferred embodiment of the present invention, the secondary winding 12 of the current mutual inductor 6 of the sample-hold circuit 4 has a center tap and is grounded, so that the sensed voltage signal of the secondary winding 12 of the current mutual inductor 6 of the sample-hold circuit 4 is an ideal difference mode signal having the same magnitude and the opposite direction. The ideal difference mode signal is filtered by the RC low pass filter 5 consisting of the resistors R6 and R7 and the capacitors C9 and C10 to filter various entering interference signals having high frequency. Then, the filtered ideal difference mode signal is amplified by the difference to operation amplifier consisting of the resistors R6, R7, R8 and R9, the capacitor C11 and the operational amplifier 8. Then, the amplified ideal difference mode signal is sent through the delay-action circuit 22 (including the diode D8, the resistor R10 and the capacitor C12) into the compare and execution circuit 14 which includes the operational amplifiers U2B, U2C and U2D, and the control element 16. The control element 16 controls operation of the relay 2 according to operation of the operational amplifiers U2B, U2C and U2D so as to turn on or turn off the relay 2. Thus, the electricity limit protection switch can achieve an electricity limit protection purpose by sensing the magnitude of the current passing through the load 1.

In the preferred embodiment of the present invention, the working conditions of the electricity limit protection switch are set as follows. The rated input voltage is 120 VAC/60 Hz of a tungsten lamp, and the electricity limit protection switch is connected between the load 1 and the mains power supply. Thus, when the magnitude of the current passing through the load 1 is smaller than 1.625 A, the electricity limit protection switch will not shut connection between the load 1 and the mains power supply, and when the magnitude of the current passing through the load 1 is greater than 1.625 A, the electricity limit protection switch will delay about one to four (1-4) seconds to shut the connection between the load 1 and the mains power supply so as to limit the electricity.

According to the law established by the California government of U.S.A. in 2006, the maximum rated power of the load of a tungsten lamp of 120 VAC/60 Hz cannot exceed 190 W. Thus, operation of the electricity limit protection switch is set as follows.

When the power of the load is not greater than 190 W, the load 1 is turned on, and the electricity limit protection switch is disposed at an indication state. For example, a first light emitting diode D9 (see FIG. 2) of the electricity limit protection switch emits a green light to indicate that the load 1 is turned on. When the power of the load is greater than 190 W, the electricity limit protection switch will delay about one to four (1-4) seconds to shut the connection between the load 1 and the mains power supply so as to turn off the load 1. At the same time, the first light emitting diode D9 is extinguished, and a second light emitting diode D2 (see FIG. 2) of the electricity limit protection switch emits a red light to indicate that the load 1 is turned off and to remind the user of overload of the load 1.

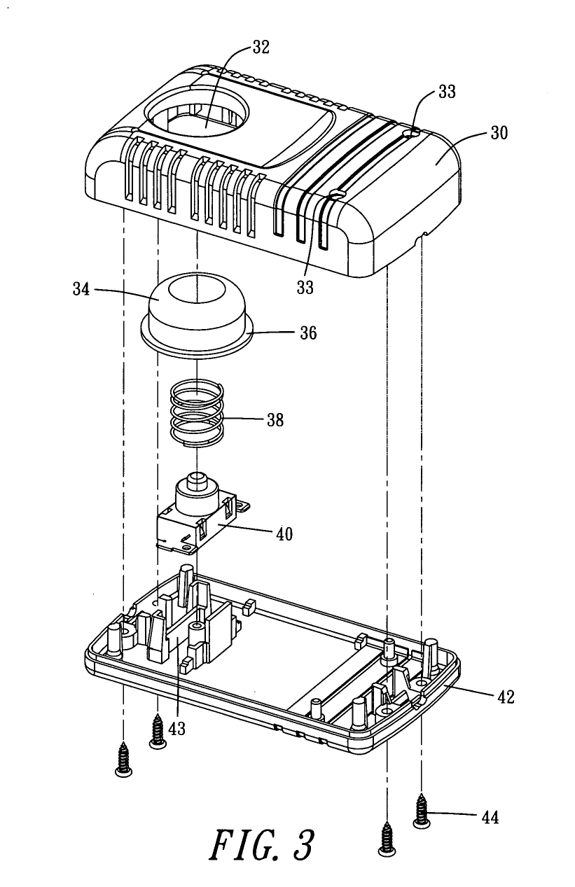

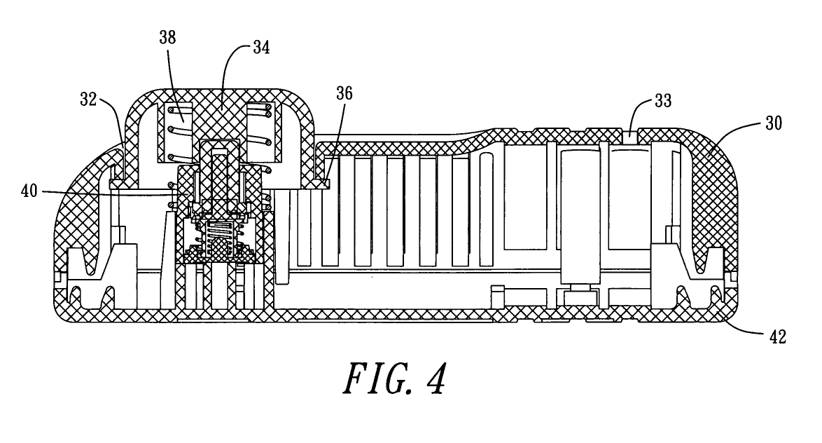

Referring to FIGS. 3 and 4 with reference to FIGS. 1 and 2, the electricity limit protection switch in accordance with the preferred embodiment of the present invention comprises a circuit board made of the circuit device as shown in FIG. 2, and further comprises a housing 42 having an inside formed with a locking groove 43, a top cover 30 combined with the housing 42 by a plurality of screw members 44 and having a first side formed with a mounting hole 32 and a second side formed with two through holes 33 to expose the first light emitting diode D9 and the second light emitting diode D2 (see FIG. 2) of the circuit board, a switch member 40 mounted in the locking groove 43 of the housing 42, a push button 34 movably mounted in the mounting hole 32 of the top cover 30 and movable to touch the switch member 40, and an elastic member 38 mounted on the switch member 40 and biased between the push button 34 and the switch member 40 to push the push button 34 outwardly from the switch member 40. The push button 34 is pushed by the elastic member 38 to partially protrude outwardly from the mounting hole 32 of the top cover 30 and has a peripheral wall formed with an annular lip 36 that is movable to rest on the bottom wall of the mounting hole 32 of the top cover 30 to prevent the push button 34 from being detached from the mounting hole 32 of the top cover 30. The switch member 40 has an inside contains the relay 2. Alternatively, the switch member 40 functions as the relay 2. In assembly, the switch member 40 is initially combined with the circuit board made of the circuit device. Then, the switch member 40 is placed into the locking groove 43 of the housing 42, and the circuit board is placed into the inside of the housing 42.

In practice, when the power of the load is greater than the preset rated value, the electricity limit protection switch will shut the relay 2 in the switch member 40 so as to turn off the load 1. After the overload situation is removed, the push button 34 is pressed to touch the switch member 40 to contact and conduct the relay 2 in the switch member 40 again so as to connect the load 1 and the mains power supply. When the push button 34 is pressed again at the next time, the relay 2 is shut again. In such a manner, the push button 34 is pressed successively to turn on or turn off the relay 2. Thus, the electric power between the load 1 and the mains power supply is turned off by an overload or by pressing the push button 34 manually. On the contrary, the electric power between the load 1 and the mains power supply is turned on after the overload situation is removed or by pressing the push button 34 manually. Thus, the electricity limit protection switch can achieve an electricity limit protection purpose and can function as a common switch.

Accordingly, the electricity limit protection switch can achieve an electricity limit protection purpose by sensing the magnitude of the current passing through the load 1. In addition, the electricity limit protection switch can achieve an electricity limit protection purpose and can function as a common switch, thereby enhancing the versatility of the electricity limit protection switch.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electricity limit protection switch, comprising a circuit device comprising:
a relay electrically connected to a load;
a sample-hold circuit including a current mutual inductor and a first operational amplifier, wherein the current mutual inductor includes a primary winding and a secondary winding, the primary winding of the current mutual inductor is electrically connected to the relay and the load;
a compare and execution circuit used to receive a signal from the sample-hold circuit and electrically connected to the relay, wherein the compare and execution circuit includes a plurality of second operational amplifiers to operate the signal from the sample-hold circuit, and a control element to control operation of the relay according to operation of the operational amplifiers so as to turn on or turn off the relay.

2. The electricity limit protection switch in accordance with claim 1, wherein the secondary winding of the current mutual inductor of the sample-hold circuit has a center tap and is grounded.

3. The electricity limit protection switch in accordance with claim 1, wherein the control element is a silicon controlled rectifier (SCR).

4. The electricity limit protection switch in accordance with claim 1, wherein the sample-hold circuit further includes a RC low pass filter consisting of resistors and capacitors.

5. The electricity limit protection switch in accordance with claim 1, wherein the sample-hold circuit further includes a difference to operation amplifier consisting of resistors, a capacitor and the first operational amplifier.

6. The electricity limit protection switch in accordance with claim 1, wherein the circuit device further comprises a delay-action circuit connected between the sample-hold circuit and the compare and execution circuit and including a diode, a resistor and a capacitor.

7. The electricity limit protection switch in accordance with claim 4, wherein the RC low pass filter receives a signal from the current mutual inductor to filter various entering interference signals having high frequency.

8. The electricity limit protection switch in accordance with claim 5, wherein the difference to operation amplifier receives a signal from the RC low pass filter to amplify a difference mode signal and suppress a common mode signal.

9. The electricity limit protection switch in accordance with claim 8, wherein the compare and execution circuit receives a signal from the difference to operation amplifier of the sample-hold circuit.

10. The electricity limit protection switch in accordance with claim 9, wherein the second operational amplifiers of the compare and execution circuit operate the signal received from the difference to operation amplifier of the sample-hold circuit.

11. The electricity limit protection switch in accordance with claim 9, wherein the circuit device further comprises a delay-action circuit connected between the sample-hold circuit and the compare and execution circuit and including a diode, a resistor and a capacitor, wherein the delay-action circuit receives the signal amplified by the difference to operation amplifier of the sample-hold circuit.

12. The electricity limit protection switch in accordance with claim 1, further comprising:
a housing having an inside formed with a locking groove;
a circuit board made of the circuit device and received in the inside of the housing;
a top cover combined with the housing and having a first side formed with a mounting hole;
a switch member mounted in the locking groove of the housing;
a push button movably mounted in the mounting hole of the top cover and movable to touch the switch member;
an elastic member mounted on the switch member and biased between the push button and the switch member to push the push button outwardly from the switch member.

13. The electricity limit protection switch in accordance with claim 12, wherein the switch member is combined with the circuit board made of the circuit device.

14. The electricity limit protection switch in accordance with claim 12, wherein the push button is pushed by the elastic member to partially protrude outwardly from the mounting hole of the top cover.

15. The electricity limit protection switch in accordance with claim 12, wherein the push button has a peripheral wall formed with an annular lip that is movable to rest on a bottom wall of the mounting hole of the top cover to prevent the push button from being detached from the mounting hole of the top cover.

16. The electricity limit protection switch in accordance with claim 12, wherein the switch member has an inside contains the relay.

17. The electricity limit protection switch in accordance with claim 12, wherein the top cover is combined with the housing by a plurality of screw members.

18. The electricity limit protection switch in accordance with claim 12, wherein the top cover has a second side formed with two through holes.
